(19) United States
(12) Patent Application Publication
(10) Pub. No.: US 2019/0134877 A1
(43) Pub. Date: May 9, 2019

(54) ARRANGEMENT OF THE TRANSPORT PATH TO THE CLOSING UNIT FOR A STATIONARY BLOW MOULDING MACHINE

(71) Applicant: KRONES AG, Neutraubling (DE)

(72) Inventors: CHRISTIAN STOIBER, Michelsneukirchen (DE); EDUARD HANDSCHUH, Donaustauf (DE); KLAUS VOTH, Obertraubling (DE); ROBERT SCHEIBENPFLUG, Pfatter (DE); KONRAD SENN, Alteglofsheim (DE); ADAM BIALEK, Regensburg (DE)

(73) Assignee: KRONES AG, Neutraubling (DE)

(21) Appl. No.: 16/096,900

(22) PCT Filed: May 10, 2017
(86) PCT No.: PCT/EP2017/061219

§ 371 Date: Oct. 26, 2018

(30) Foreign Application Priority Data
May 10, 2016 (DE) 10 2016 108 586.3

(51) Int. Cl. B29C 49/42; B29C 49/56; B29C 49/58

(52) U.S. Cl. CPC B29C 49/4205; B29C 49/4289; B29C 2049/5803; B29C 49/58; B29C 49/56

(57) ABSTRACT

Provided is an apparatus for transforming plastic parisons into plastic containers with a transport device which transports the plastic parisons along a predetermined transport path, with at least one transforming station which is arranged in a stationary manner along this transport path. The transforming station has a blow mould which can be opened and closed and which in a closed state forms a cavity inside which the plastic parisons can be transformed into the plastic containers by the application of a gaseous medium. The transforming station has a closing unit in order to close the blow mould and this closing unit has at least one component of the blow mould which is movable relative to another component of the blow mould.

### CROSS-REFERENCE TO RELATED APPLICATIONS

This application claims priority to PCT Application No. PCT/EP2017/061219, having a filing date of May 10, 2017, based on German Application No. 10 2016 108 586.3, having a filing date of May 10, 2016, the entire contents both of which are hereby incorporated by reference.

### FIELD OF TECHNOLOGY

The following relates to an apparatus for handling plastic parisons and in particular for producing plastic bottles. Such apparatus have been known for a long time from the prior art. In this case it is known in particular that first plastic parisons are heated and are then transformed or blow moulded in blow moulding machines to form containers. Such blow moulding machines are usually rotary machines, in which a plurality of transforming stations is arranged on a rotatable carrier.

### BACKGROUND

In addition, stationary blow moulding machines, to which the plastic parisons are supplied for expansion and in which the plastic parisons are blow moulded in a stationary state, are also known from the prior art. The simple construction known in the prior art with a small number of transfer points makes it possible, when rotary machines are used, to achieve a continuous process sequence and as a result high outputs. In the linear machines which are likewise known and in particular are arranged in a stationary manner, the position at which the stretch blow moulding takes place is locally fixed. Therefore, this machine type is frequently also designated as a stationary stretch blow moulding machine.

Only the parison and bottle transport is carried out, the actual blow moulding station remains in its position. In linear machines the blow moulding stations are equipped with several individual cavities arranged one behind the other in order to increase the machine output. However, the number of these cavities cannot be augmented arbitrarily. The disadvantage of such rotary machines is that large masses have to be accelerated, decelerated and kept at a constant rotational speed in normal operation. The extremely stable basic structure as well as a smooth and precise mounting of the heavy blow moulding wheel are complex and expensive. Because of the limited accessibility the handling parts changeover is also made more difficult. In addition, high accelerations of parisons occur, by which the preheated (and therefore soft) plastic parison is partially deformed.

Due to the construction, linear machines achieve lower bottle outputs per cavity than rotary machines. They are therefore suitable primarily for applications with a low required productivity. When linear and stretch blow moulding machines are used, such machines have a heating system usually based on a chain which is equipped with receiving mandrels. The plastic parisons are heated in this circumferential chain.

By means of an electrical or pneumatic handling system the plastic parisons are transferred into a closing unit of the transforming device or of the blow moulding machine. In this case, however, there is the disadvantage that in the oven the pitch of the plastic parisons is fixed and is not variable. Moreover, a pitch delay from the chain pitch in the oven to the mould pitch in the closing unit must be carried out (usually by means of a handling system).

### SUMMARY

An aspect relates to an apparatus which, on the one hand, simplifies the handover of the plastic parisons and, on the other hand, nevertheless enables a construction which is as compact as possible.

An apparatus according to embodiments of the invention for transforming plastic parisons into plastic containers has a transport device which transports the plastic parisons along a predefined transport path. Furthermore, the apparatus has at least one transforming station, which is arranged in a stationary manner along this transport path, wherein the transforming station has a blow mould which can be opened and closed and which in a closed state forms a cavity inside which the plastic parisons can be transformed into the plastic containers by the application of a flowable and in particular gaseous medium.

Furthermore the transforming station has a closing unit in order to close the blow mould and this closing unit has at least one component of the blow mould which is movable relative to another component of the blow mould and, furthermore, the transforming station has an application device which can be applied to a mouth of the plastic parisons in order to apply the flowable and in particular gaseous medium thereto. Furthermore, the machine has a valve unit in order to control the flowable and in particular gaseous medium to be delivered to the plastic parisons (or in order to control the delivery of this medium to the respective plastic parisons).

According to embodiments of the invention the blow mould or the transforming station has a wall surrounding it at least partially in a circumferential direction and the valve unit is arranged at least partially and preferably completely inside this wall. However, it would also be conceivable for the valve unit to extend through a wall portion of this wall.

A stationary transforming station is understood in particular to be a transforming station which has movable elements but as a whole is arranged in a stationary manner. In particular this is a transforming device which allows a transformation of the plastic parisons into plastic containers when they are in a stationary standstill, i.e. the plastic parisons are preferably not transported during the transformation.

However, following is also directed to an apparatus of the type described above (i.e. according to the preamble of claim 1), in which the transport device has at least one diverting device which enables a distribution of a stream of plastic parisons from at least one and preferably precisely one supply branch to two or more discharge branches. As explained in greater detail below, it would be desirable if the respective transport times or transport paths between a heating device and a subsequent transforming station are the same length, so that a uniform heating of all plastic parisons can be carried out even in a stationary transforming station. For this purpose, it is possible to distribute the stream of plastic parisons substantially simultaneously to several transforming stations. Advantageously, here too—as explained in greater detail below—this is a transport device which has a plurality of transport elements which are movable independently of one another.

The diverting device is advantageously a controllable diverting device, so that for example plastic parisons from one supply branch can be distributed alternately to several discharge branches. This procedure is suitable in particular if the transport device is an electromagnetically operated transport device which for example has a long stator with a plurality of magnetic elements.

It is pointed out that this embodiment is possible even without the configuration described above, according to which the valve unit is arranged inside the said wall or also according to which a corresponding wall must actually be provided.

Furthermore, the following is directed to an embodiment in which the closing unit has a drive unit which serves for closing and opening the blow moulds and this drive unit in turn has a coupling mechanism which couples at least one movement of the first blow mould part to a movement of the second blow mould part. In particular the movement of two blow mould parts towards one another can be achieved by this coupling mechanism, which is described in greater detail below.

This coupling mechanism is preferably configured so that two side parts of the blow mould are advanced simultaneously towards the plastic parisons to be expanded or towards the transport path of these plastic parisons. In this case the two side parts can be moved particularly preferably synchronously by this coupling mechanism.

In an advantageous embodiment this coupling device also enables connection of a base part. In this way it is possible that with only one drive, and in particular a linear drive, both the two side parts of the blow mould and the base part can be moved substantially simultaneously. Advantageously here the movements of the blow mould parts as well as the base part are linear movements. For this purpose, this coupling device preferably has a plurality of coupling elements, such as for example coupling rods, which at least in part are connected to one another in an articulated manner.

This driving device is advantageously arranged below a blow mould, in order in this way to carry out the opening and closing movement in the least disruptive way possible and/or in a space-saving manner.

In a further advantageous embodiment, carriers of the blow mould parts are arranged on a slide which enables a corresponding movement, in particular a linear movement, of these blow mould parts. These slides preferably move perpendicularly to the transport direction of the plastic parisons.

The flowable medium is preferably air and in particular compressed air. However, other flowable media, such as for example other gases or also liquids would also be conceivable. An arrangement of the valve unit inside the wall is understood to mean that the valve unit, as well as the blow moulds themselves are arranged inside the said surrounding wall.

The above-mentioned circumferential direction (in which the wall surrounds the transforming device) is in particular a direction which is perpendicular to the transport direction of the plastic parisons. Therefore, the said wall preferably surrounds a space inside which the valve unit is arranged. The plastic parison is preferably also arranged inside this wall.

The aforementioned closing unit preferably has at least two mould carrier halves which in each case accommodate the mould halves of a blow mould. These mould carrier halves are advantageously guided by means of guides and in particular by means of linear guides and particularly preferably by means of at least one drive, possibly also by means of several drives. These drives are in particular linear drives and particularly preferably electrical linear drives.

If the plastic parison is positioned between the two mould carrier halves, these can be closed, and the application device is supported on the mouth or the support ring of the plastic parison and preferably seals a high-pressure feed line. Furthermore, it would also be conceivable that this application device, in particular a blow moulding nozzle, is supported on the mould in order to seal the high-pressure feed line. A locking mechanism can preferably be provided which locks the two blow mould halves to one another. Thus, for example, also in order to absorb the forces in the transformation process, behind the respective mould support a lock can be lowered, so that the complete system is form-fitting.

The circumferential wall is preferably at least substantially closed in a closed state of the blow mould. Advantageously the circumferential wall is always closed and also serves for stabilisation of a closed state of the respective blow moulds. However, it would also be possible that the circumferential wall is likewise opened for opening the blow moulds.

However, the circumferential wall is preferably always closed and forms a frame and in particular a yoke. Inside this frame the blow mould can be opened and closed.

In a further advantageous embodiment, the valve unit has a plurality of valves for controlling different pressure stages. Thus, for example a preliminary blow moulding pressure which has a certain pressure can be supplied to the plastic parisons. A (higher) intermediate blow moulding pressure can follow this preliminary blow moulding pressure. This intermediate blow moulding pressure can be followed by a final blow moulding pressure by which the plastic containers are ultimately moulded and are kept in a moulded state. In addition, the valve unit can also have an outlet for the flowable medium, so that when the moulded containers are relieved of pressure the compressed air can be let out again (at least partially). In this case this outlet can be arranged inside the frame (this may be expedient for soundproofing reasons), but also outside the frame (for example if a sterile room is to be formed by the frame).

In a preferred embodiment the said valve block therefore has a plurality of valves and high-pressure valves. In this case it is possible that these valves themselves are also pneumatically controlled. However, an electrical, magnetic or also hydraulic control would also be conceivable. In a further advantageous embodiment, a control device is also provided for controlling the individual valves of this valve block. In this case this control device can for example control different pressure stages during an expansion operation of the plastic parisons.

In a further advantageous embodiment, the said valve block is offset laterally with respect to a transport direction of the plastic parisons or with respect to the transport path. Space can likewise be saved due to this laterally offset arrangement. Thus, in particular the space surrounded by the wall or the frame can be kept smaller. For example, it is possible that the valve block is arranged below the wall or the frame and for example is offset to the right or left relative to the transport path. Furthermore, in this way dead space volume is also reduced.

In a further preferred embodiment, a heating device or an oven is connected upstream of the actual transforming device or the blow mould device. This oven can for example be an infrared oven, but it would also be conceivable to use microwave ovens.

In a further advantageous embodiment, the blow moulds or the parts thereof are arranged on blow mould carriers. In this case these carriers can be moved with respect to one another in order to open and to close the blow moulds. Furthermore, in this case it would be possible that between at least one blow mould and at least one blow mould carrier a pressure pad is arranged, that is to say an element which for example can be acted upon by compressed air, in order thus to advance parts of the blow mould towards one another.

In a further advantageous embodiment, the application device is a blow moulding nozzle. This blow moulding nozzle can be advantageously advanced towards the blow moulds and/or the plastic parison and in particular can at least also be advanced in a longitudinal direction of the plastic parisons to be expanded. In this case it is also possible that the valve block itself is movable in the direction of the longitudinal axis of the plastic parisons.

In a further advantageous embodiment at least one of the two transport devices is a circumferential transport device. This means that the individual transport elements of this transport device are guided along a circumferential movement path. In a further advantageous embodiment, it is also possible that at least one transport device takes on a pitch delay, for example it increases a pitch between the individual plastic parisons between the heating device and the following actual transforming station.

In a further advantageous embodiment, the closing unit has a linear drive for opening and closing the blow moulds. In this case the blow mould can have two side parts and a base part as components. In this case it is possible that at least at times the side parts and the base part are moved simultaneously. Several procedures are conceivable for opening and closing the blow mould. Thus, it would be possible that only one side part is moved for opening and closing. Furthermore, however, it would also be possible and is preferred that at least temporarily both side parts or both side part carriers are moved simultaneously for opening and closing the blow mould. This facilitates introduction of the plastic parisons into the blow moulds. Furthermore, it is also possible that the base part is advanced towards the two side parts and for this purpose for example is moved in a longitudinal direction of the plastic parisons to be expanded. Furthermore, in this case it is also possible that at least a portion of the side parts engages in a portion of the base part, in order thus to connect or even to lock these blow mould parts to one another.

In a further advantageous embodiment, the apparatus also has a rod-like body which can be introduced into the respective plastic parisons (in particular by means of the mouths thereof) in order to expand these parisons in their longitudinal direction. In this case it is preferably possible that a drive for this rod-like body is arranged outside the above-mentioned wall. It is also conceivable that a carrier device which supports and/or guides this rod-like carrier is arranged outside the region surrounded by the above-mentioned wall. This rod-like body is advantageously movable in a longitudinal direction of the plastic parisons to be expanded.

In a further advantageous embodiment, the transport device has a carrier, as well as transport elements which are arranged on this carrier and are movable independently of one another relative to this carrier. Due to this configuration the transport device can also take on the above-mentioned pitch delay. In this case, as mentioned above, this carrier is advantageously designed circumferentially and preferably extends in one plane. In this case this transport plane of the transport elements can be arranged for example horizontally, but it can also extend vertically or in an inclined direction. This is explained in greater detail with reference to the drawings.

In a further advantageous embodiment, the transport device extends at least partially through a space surrounded by the circumferential wall. A part of the transport device advantageously extends inside this circumferential wall and a part of the transport device extends outside it. In this case it is also possible that the transport device extends partially through the region or space surrounded by the circumferential wall in such a way that for instance a radially outer region of the transport device extends inside the space and a radially inner region extends outside the space.

In a further advantageous embodiment gripping elements for gripping the plastic parisons are arranged in each case on the individual transport elements. These could be for example mandrels which can be introduced into the mouths of the plastic parisons. Preferably, however, these holding elements are gripping elements, such as gripping clamps, which can grip the plastic parisons, for example below their carrying ring or also below their thread. In this case they are advantageously controllable gripping elements, that is to say gripping elements of which the opening and closing movement can be actively controlled. For this purpose, drive units, such as for example electrical drives, pneumatic drives, magnetic drives and the like, for actuating the respective gripping elements can be arranged in each case on the transport elements. In this case these gripping elements can be supplied with current starting from the transport device or the circumferential carrier.

In a further advantageous embodiment, the transport device has magnetic drive means or magnetic drive for moving the transport elements. Thus, for example electromagnets can be arranged on the carrier and permanent magnets can be arranged on the respective transport elements. By a corresponding supply of current to these electromagnets individual transport elements can be moved relative to the carrier. Furthermore, guide elements are preferably also provided which guide the movement of the transport elements relative to the carrier. Thus, for example rollers can in each case be arranged for example on the transport elements, these rollers being intended for mounting of the transport elements relative to the carrier and in order to keep a specific distance between the transport elements and the carrier.

In a further advantageous embodiment, the above-mentioned wall is constructed as a frame and parts of the blow moulds are arranged on this frame. Thus, the drive which serves for movement of the blow mould part can be provided for example on a base of this frame.

In this case it would be possible that the entire frame is opened and closed, in order to open and to close the blow moulds. Advantageously, however, the frame is a permanently closed frame which in particular is also suitable and intended for absorbing the forces produced during the transformation operation.

Therefore, in a further advantageous embodiment the frame provides a force for locking at least one blow mould. Thus, for example locking elements for locking the blow moulds can be inserted between a wall of the frame or a portion of the frame and the respective blow moulds, so that ultimately the force for locking is applied by the frame itself.

In a further advantageous embodiment, the apparatus has a locking mechanism for locking the frame (and/or the blow moulds and/or the blow mould carriers). Thus, it is preferably possible for the blow mould parts to be clamped relative to the said frame, as mentioned above, for example by interposition of a locking element.

In a further advantageous embodiment, the apparatus has at least two blow moulds which are suitable and intended for transforming plastic parisons. In this case these two blow moulds are preferably arranged along a rectilinear portion of the transport device and/or of the transport path of the plastic parisons in particular one after the other. In this case it would be possible that these two blow moulds can be opened and closed independently of one another. However, it would also be possible that at least one blow mould device has a double cavity or generally a multiple cavity, into which several plastic parisons can be introduced simultaneously.

Fundamentally in the construction of such stretch blow moulding machines or blow moulding machines in general several procedures are conceivable. Thus, for example it would be possible that in a blow moulding machine of modular construction, and in particular a stretch blow moulding machine, several blow moulding modules and/or heating modules are arranged adjacent to one another. This can be configured as a fully modular or partially modular system. In this case it would also be possible that the transport device has a diverting device which distributes individual plastic parisons to a first blow moulding module and others to a second blow moulding module.

After the outlet from a holding system the heated plastic parisons preferably run through a transport path, before they are delivered to a standard blow moulding station. After completion of the blow moulding process the plastic parisons leave the transforming station preferably on the opposite side. There all blow moulded bottles can be brought together again into a stream. In this case the blow mould device or the blow moulding module can have the actual blow moulding station, a delivery system for the plastic parisons and a discharge system for the manufactured bottle.

By a modular expansion it is also possible to increase a machine output linearly by several blow moulding modules which are attached for example in a row. In this case each further blow moulding module preferably has the same components as the first-mentioned module. When several modules are lined up together the transfer time between the holding system and the individual blow moulding stations should preferably be kept constant for each module. The transfer time should not be varied, regardless of whether the first station is occupied or the last, which can otherwise set a different temperature profile in the plastic parisons. However, it would also be possible to take account of such a different temperature profile in the subsequent blow moulding process, for instance by corresponding influence on the pressure conditions of the blow moulding.

Furthermore, as mentioned above, it is also possible that the individual stretch blow moulding module has several cavities. A synchronous control of a plurality of cavities also enables the reduction of the drive units and thus leads to a reduction in the cost of the entire installation. On the other hand, however, too many cavities in the row result in a drop in output of the system by comparison with one cavity. The possible productivity rates, for example 2000 containers per cavity and hour, and the process time, that is to say the blow moulding and cooling time while the blow moulds remain closed, are more favourable in the case of a single or double cavity than in the case of multiple cavities, for example triple or quadruple cavities. Therefore, if several cavities are used, the individual outputs are significantly reduced. A further criterion is also the size of the individual cavities or the size of the containers to be produced. In the case of small cavities, a triple blow mould for example may also still be cost-effective.

Furthermore, with a preferred design, for example a fully modular design, it would also be possible, in order to compensate for the time difference between the heating time and the blow moulding time, to operate parallel processing on a respective station-based heating module. In this case the heating of the plastic parisons takes place with an effective heating system in order to achieve the cycle times. This heating system can be for example a STIR or a microwave heating system. In this case an own heating element is preferably associated with each transforming station.

More precisely, it is possible that an own heating means or heater is positioned before each blow moulding module or each transforming station. In this case for example the transforming device in a standard design can have for example two linearly arranged blow mould cavities which are supplied with heated plastic parisons by the heating module. Here too the transport system for the plastic parisons and/or the containers is preferably based on the principle of a linear synchronous motor. In this case each plastic parison is taken up by an own drive unit and is transported through the entire system.

A distribution of the plastic parisons to the individual modules is preferably implemented directly by means of the transport system. In this way an additional transfer is not necessary. Such a machine design offers clear advantages with regard to the flexibility by comparison with constructions known from the prior art. The modular construction of the individual heating means or heater described here constitutes a high potential for added value. In fact, the modular construction enables a simple construction and in principle any enhancement of the entire machine design. The operation of individual modules with simultaneous setup work on the neighbouring modules is therefore likewise possible, in particular if a flexible transport system is presupposed.

Such a flexible transport system advantageously has the possibility of both separating a stream of plastic parisons and combining it again. This should advantageously take place without transferring the plastic parisons to further transport systems. In this case the embodiment of a linear synchronous motor described above is particularly suitable, since this has a plurality of transport elements which can be moved independently of one another.

In this case, as mentioned above, diverting devices can be additionally provided in order for example to distribute a stream of plastic parisons to two branches. The applicant therefore reserves the right, independently of the above-mentioned arrangement of the valve unit in the wall or inside the wall, also to claim the transport system with diverting devices which is mentioned here.

In order to comply with the respective cycle times of the station it is conceivable that, depending upon the size of the installation, a parking zone before the heating system or the transforming stations is taken into consideration. As a rule, intermediate parking or buffering of the cold plastic parisons and/or the finished containers has no negative effects on the container quality and can therefore be used. However, it is possible to dispense with such intermediate parking if the transport systems achieve the necessary requirements with regard to dynamics.

In order preferably to produce the modular construction a flexible and expandable container transport system as described in greater detail below is advantageous. This transport system should have a high degree of configurability. In preferred embodiments the transport system is modular, has a high reliability and ease of maintenance and allows the necessary speed and the necessary accelerations to be produced.

In addition, a regulability and controllability should also be provided, in addition an energy efficiency and a temperature resistance. In addition, the transport system or the transport device should also enable a sufficient payload. Furthermore, the magnetic systems described here enable the implementation of a constant transfer time between an oven and the individual transforming stations. As already mentioned above, the apparatus preferably has a heating device for heating the plastic parisons to be delivered to the blow moulds, as well as a second transport device which conveys the plastic parisons through this heating device, wherein this second transport device preferably has a carrier as well as transport elements arranged on this carrier, which particularly preferably are movable independently of one another relative to this carrier.

As mentioned above, this heating device is advantageously a linear oven. This means that the transport path of the second transport device has at least one linear portion and preferably at least two linear portions parallel to one another. Here too, particularly preferably, the carrier is a long stator, that is to say a carrier which preferably has a plurality of magnetic elements such as electromagnets. The transport elements are also advantageously arranged circumferentially relative to this carrier. Moreover, the transport elements can be designed in the same way as the above-mentioned transport elements.

In a further advantageous embodiment, the system elements likewise have holding means or holder for holding the plastic parisons. These holding elements can be in particular mandrels which in each case can be introduced into mouths of the plastic containers. Advantageously the apparatus also has a rotating mechanism in order to drive these holding means or holder, such as in particular holding mandrels, for rotation with respect to the longitudinal direction (and thus also for rotation with respect to a longitudinal direction of the plastic parisons to be transported).

In this way the plastic parisons can be rotated about their own axis relative to the heating device in order thus to achieve more uniform heating of the plastic parisons.

In a further advantageous embodiment at least one element of the heating device is arranged laterally alongside the transport path of the plastic parisons transported by the second transport device and/or the plastic parisons transported by the first transport device and is in particular arranged on the right with respect to this transport path in a transport direction of the plastic parisons.

Preferably also a geometric centre of at least one blow mould is arranged laterally with respect to the transport path and particularly preferably also on the right (or left) of this transport path.

In a further advantageous embodiment (which, however, can also be used independently of the embodiments described above) at least one portion of the transport device which guides the plastic parisons through the heating device and one portion which guides the plastic parisons through the transforming device extend parallel to one another. Any electromagnetic coils of the two transport devices are preferably located at least in this portion, in which the transport devices extend parallel to one another, substantially exactly opposite to one another. In this way a “slow travel” of the plastic parisons can also be achieved in a particularly favourable manner, since then by this positioning of the coils, even in the event of “jerking” of the movement at least a “consistent jerking” is achieved.

Furthermore the following is directed to methods for transforming plastic parisons into plastic containers, wherein plastic parisons are transported by a transport device along a predetermined transport path and are transformed into the plastic containers by means of at least one transforming station which is arranged in a stationary manner along this transport path, wherein the transforming station has a blow mould which is opened and closed and which in a closed state forms a cavity inside which the plastic parisons are transformed into the plastic containers (20) by the application of a gaseous medium.

Furthermore the transforming station has a closing unit in order to close the blow mould and this closure unit has at least one component of the blow mould which is moved relative to another component of the blow mould, and, furthermore, the transforming station has an application device which is applied to a region of the blow moulds and/or of the plastic parisons in order to apply the flowable medium thereto, as well as a valve unit which controls the delivery of the flowable medium to be delivered to the plastic parisons.

In a preferred embodiment of the invention the closing unit has a wall surrounding the blow mould at least partially in a circumferential direction and the valve unit is arranged inside this wall.

Thus, also in this embodiment an arrangement the valve unit inside the circumferential wall is provided, in particular in order in this way to reduce the dead spaces which occur.

In a further embodiment according to the invention the transport device distributes a stream of the transported plastic parisons to at least two transport branches (and preferably to several transport branches), in order to be able to deliver them from a heating device connected upstream of the transforming device to a plurality of transforming stations. Preferably in this embodiment a transport time and/or transport path, which are required in order to transport the plastic parisons from the heating device to the individual transforming devices, are substantially constant.

However, it would also be possible to achieve a consistency of at least the times required in order to transport plastic parisons from the heating device to the individual transforming stations in that individual transport elements which transport the plastic parisons are moved at different speeds. Also (even in the event of use of stationary transforming stations) the respective transformation processes could be carried out at staggered time intervals.

In a further embodiment according to the invention in order to achieve the opening and closing of at least one blow mould the movements of at least two elements of the blow mould are coupled together. In this way a substantially simultaneous movement of several blow mould parts can preferably be achieved by means of only one driving device.

### BRIEF DESCRIPTION

Some of the embodiments will be described in detail, with references to the following Figures, wherein like designations denote like members, wherein:

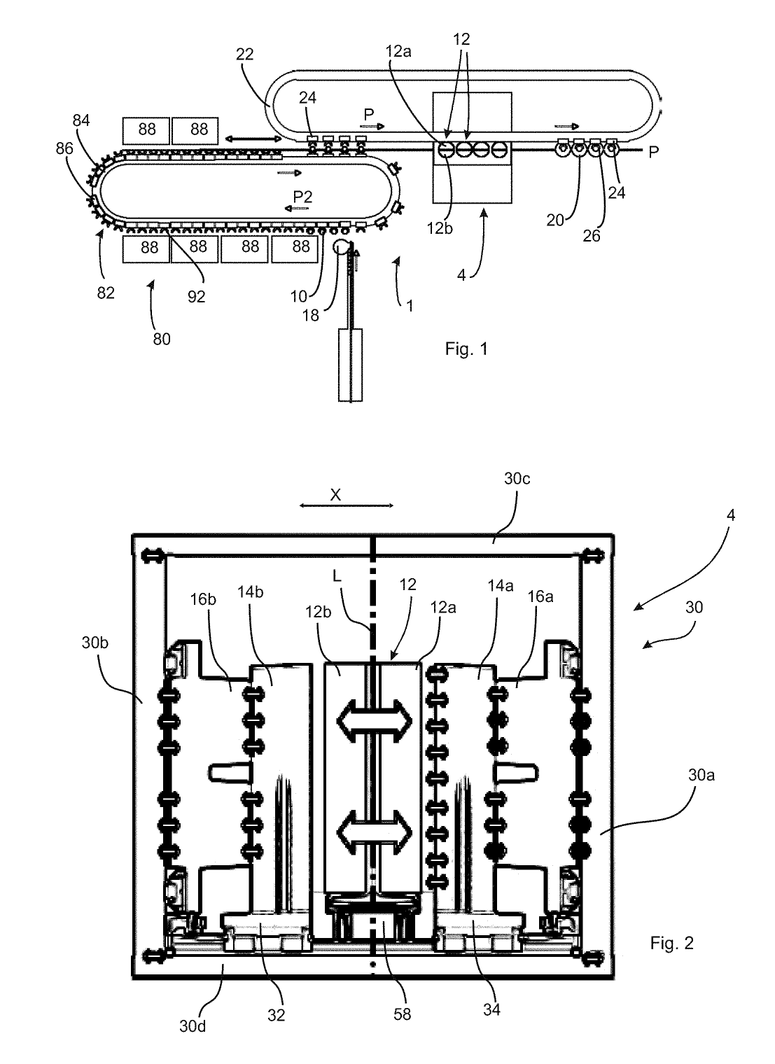

FIG. 1 shows a schematic representation of an apparatus;

FIG. 2 shows a schematic representation of a transforming station;

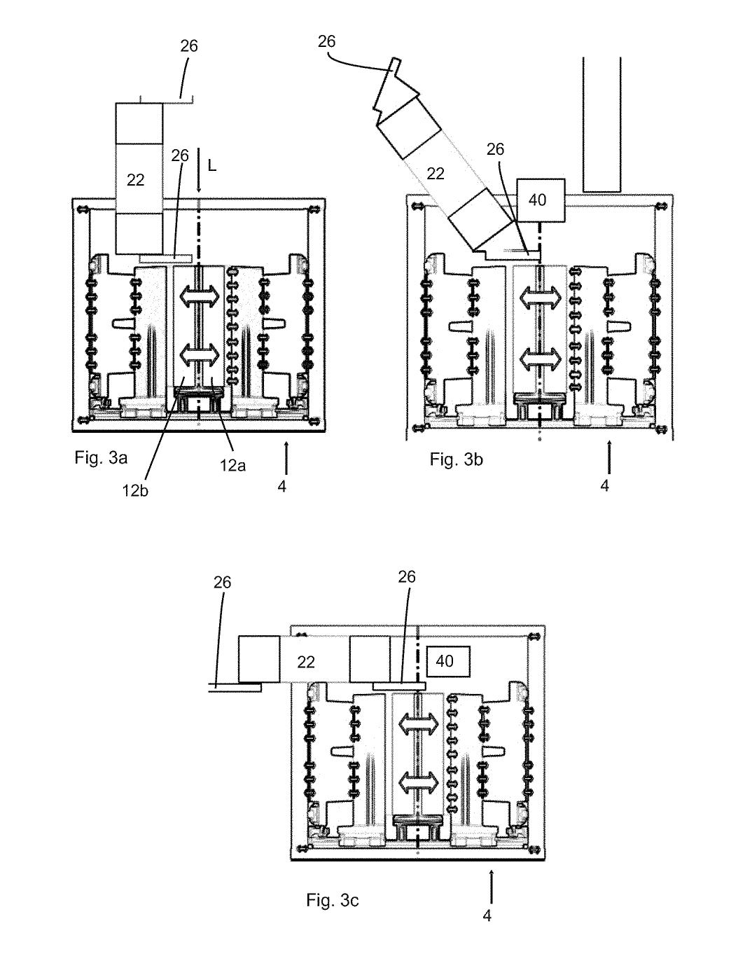

FIG. 3a shows a representation for illustration of the transport of the plastic parisons;

FIG. 3b shows another representation for illustration of the transport of the plastic parisons;

FIG. 3c shows yet another representation for illustration of the transport of the plastic parisons;

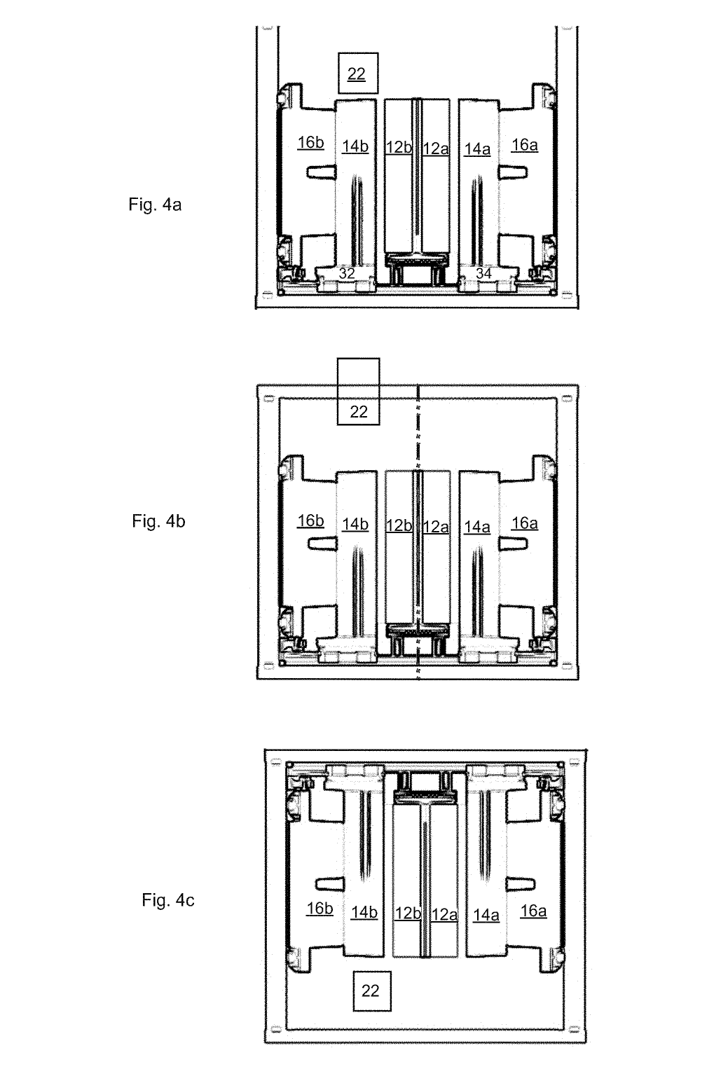

FIG. 4a shows a representation for illustration of a transforming station;

FIG. 4b shows another representation for illustration of a transforming station;

FIG. 4c shows yet another representation for illustration of a transforming station;

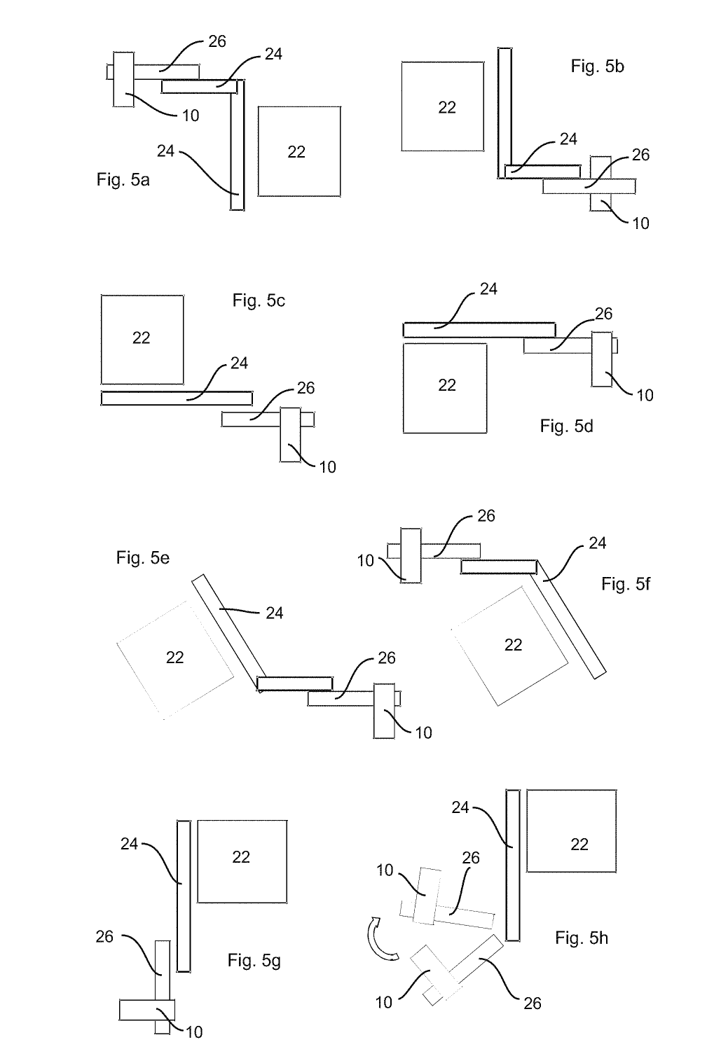

FIG. 5a shows a representation of a transport orientation;

FIG. 5b shows another representation of a transport orientation;

FIG. 5c shows another representation of a transport orientation;

FIG. 5d shows another representation of a transport orientation;

FIG. 5e shows another representation of a transport orientation;

FIG. 5f shows another representation of a transport orientation;

FIG. 5g shows another representation of a transport orientation;

FIG. 5h shows another representation of a transport orientation;

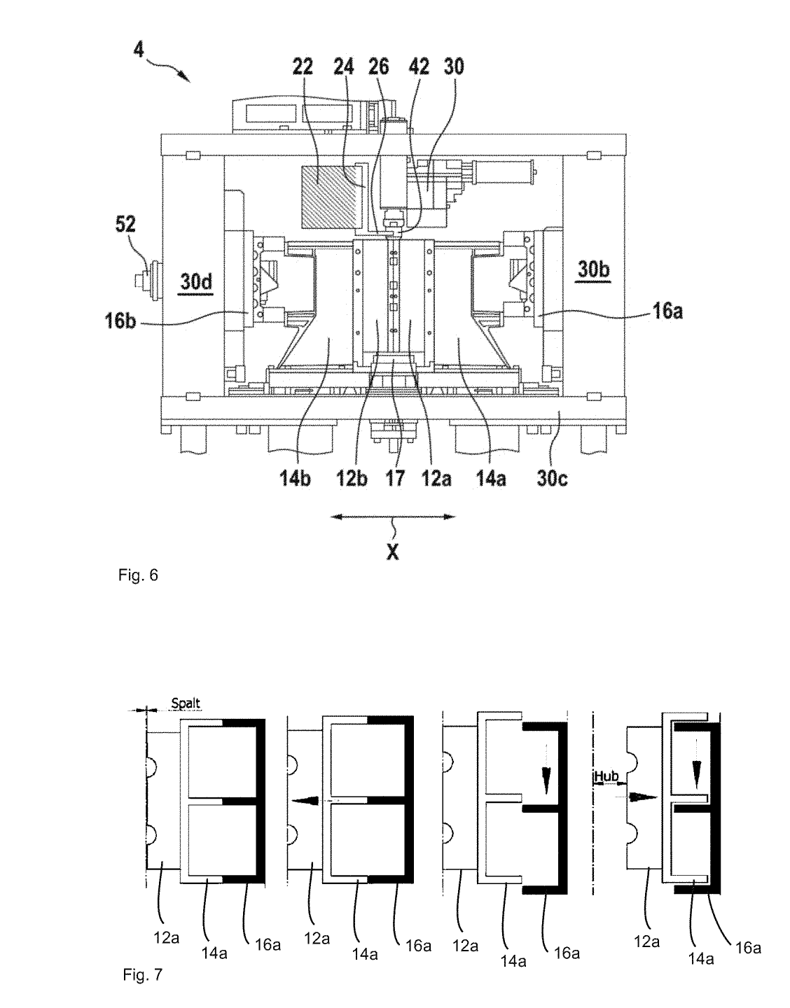

FIG. 6 shows a further representation of a transforming station;

FIG. 7 shows a representation of a locking mechanism;

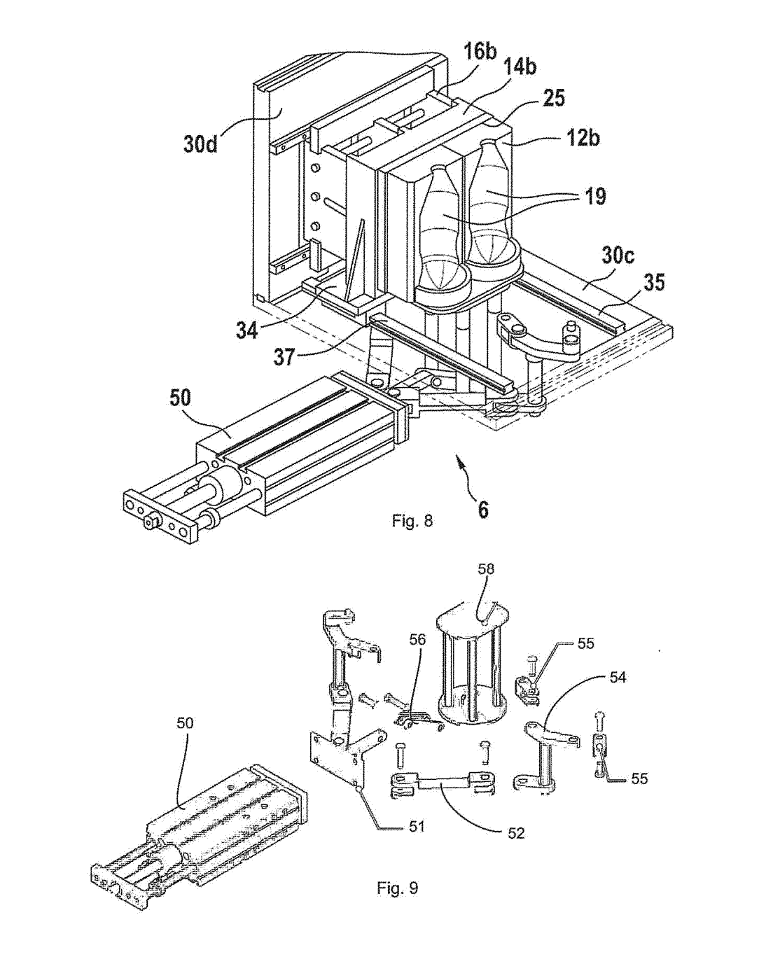

FIG. 8 shows a representation of a transforming station with closing mechanism;

FIG. 9 shows an exploded view of a coupling mechanism;

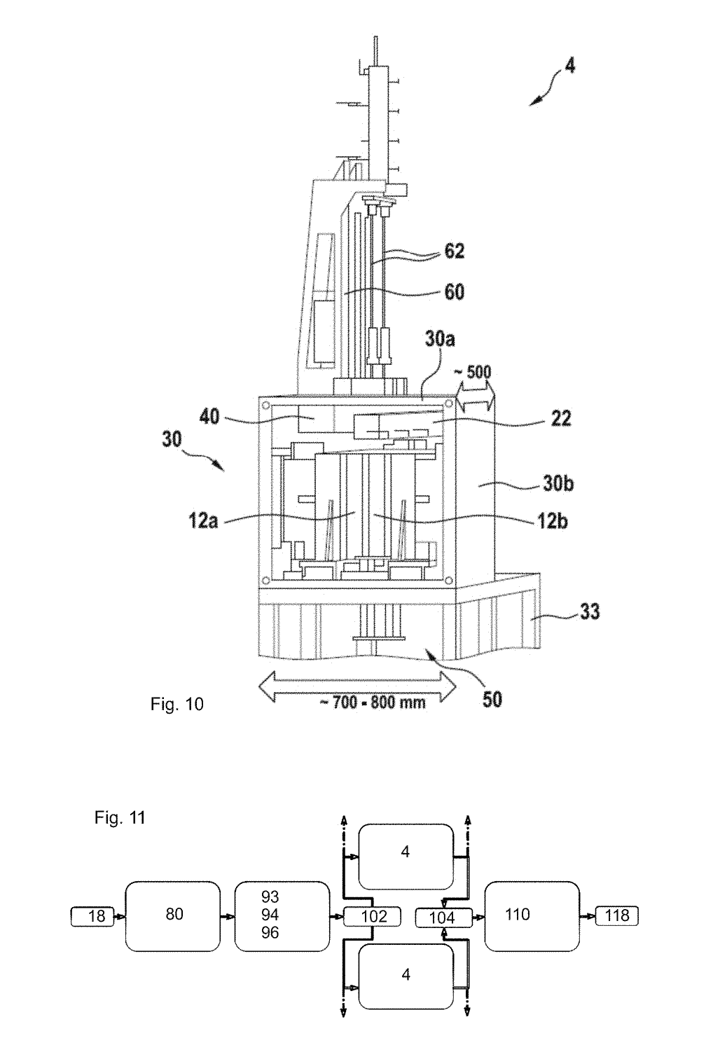

FIG. 10 shows a representation of the transforming station with stretching rod unit;

FIG. 11 shows a representation of a partially modular transport;

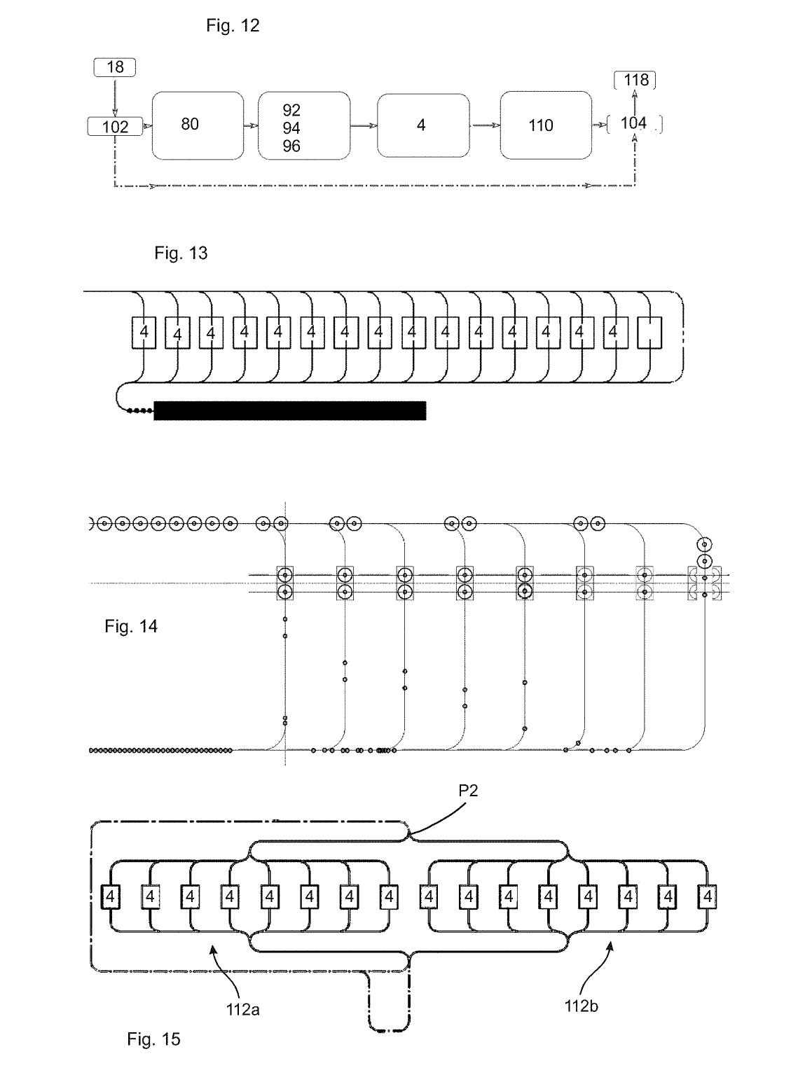

FIG. 12 shows a representation of a fully modular transport;

FIG. 13 shows a representation of a distribution of plastic parisons to several transforming stations;

FIG. 14 shows a further representation of a distribution of plastic parisons to several transforming stations; and

FIG. 15 shows a further configuration of a distribution of the plastic parisons to several transforming stations.

### DETAILED DESCRIPTION

FIG. 1 shows a schematic representation of an apparatus 1 according to embodiments of the invention for processing containers. In this case plastic parisons 10 are first delivered to a heating device designated overall by 80. This heating device here has a plurality of heating elements or heating means or heater 88 which are arranged stationary and past which the plastic parisons are transported along the transport path P2. For this purpose, the heating device has a circumferential carrier 84 on which a plurality of transport elements 86 are arranged in such a way that they can be transported independently of one another. The reference 82 designates the transport device as a whole. The reference numeral 18 designates a delivery device such as for instance a delivery star wheel for delivering the plastic parisons to the heating device 80. The reference numeral 92 designates holding devices for holding the plastic parisons.

After the plastic parisons 10 have passed through the heating device 80, the plastic parisons are transferred to first transport elements 24 or holding elements 26. These first transport elements 24 are movable relative to a first circumferential carrier 22. This circumferential carrier 22 and the transport elements 24 form the above-mentioned first transport device. The heated plastic parisons are transferred from the transport elements 24 to a transforming device designated as a whole by 4 and are transformed into the plastic containers 20 there in a plurality of blow moulds 12.

In this case the plastic parisons are transported along a transport path P. The blow moulds 12 in each case have individual blow mould parts 12a and 12b. It will be recognised here that the plastic parisons 10 are transferred from the heating device 80 to the transport device 2 along a rectilinear transport path. In this case it is possible that the first transport elements 86 of the heating device 80 are moved very slowly and accordingly the transport elements 24 can transfer the plastic parisons simply. The holding elements 92 are, unlike the illustration, preferably designed as holding mandrels which engage in the mouths of the plastic parisons 10.

Thus, two transfer circles are provided here, in particular in the form of long stators, in such a way that the transport element 24 takes up the plastic parison from the holding means or holder or the mandrel and transfers it to the transforming device 4 or the closing unit thereof. In this case on the transfer transport device the transport elements 24 have the same speed as the transport elements 86 in the heating device, in particular during transfer of the heated or warm plastic parison. In particular the transport elements 24 which are shown on the left-hand side with respect to the transforming device 4 are moved here at the same speed in each case. The transport device 2 is preferably arranged relative to the transport device 82 in such a way that the holding device 26 grips the plastic parison for example above a carrying ring.

Furthermore, unlike the illustration, it would also be conceivable that already in a diversion of the transport devices the gripper 26 of the first transport elements grips the plastic parison above a support ring, so that then in the rectilinear progression the plastic parison is completely surrounded by means of a gripping device or pincers. As soon as the holding means or holder 26 firmly grip the plastic parisons, the second holding element 92, such as for instance a mandrel, can also move out of the mouth of the plastic parison.

In this case it is possible that the transport element bearing the holding mandrel is guided or transported on one side on the carrier 22 or 82. It would also be possible that a holding means or holder, such as for instance a clamp mover, is guided on one side (on the opposing or mirror-image side) on a stator by a stationary blow mould (or a stationary transforming station). Any necessary pitch delay can advantageously also be performed on one of the illustrated transport devices.

FIG. 2 shows a schematic representation of a transforming station 4. This transforming station here has a frame 30 which has several wall sections 30a, 30b, 30c and 30d which surround the actual blow moulding arrangement in the interior. In this case these walls 30 are also constructed as a stable frame, which also serves to absorb compressive forces in the horizontal (X direction). The reference numerals 12a and 12b designate two side parts of a blow mould 12 which serves for expanding the plastic parisons. These side parts 12a, 12b are held on side part carriers 14a and 14b. The reference numerals 32 and 34 designate slides which serve to move the blow mould carriers 14a, 14b, including the side parts 12a and 12b arranged thereon, apart and together. The reference numerals 16a and 16b designate locking devices which, in the closed state of the blow mould 12, serve to lock the blow mould parts to one another. These locking elements 16a and 16b are in turn fastened to the frame sections 30a and 30b of the frame 30. The reference numeral 58 relates to a base part carrier on which a base part of the blow mould is arranged. The reference letter L designates a longitudinal direction of the plastic parisons and also the direction of movement in which the base part is delivered to the respective plastic parison.

FIGS. 3a to 3c show three representations for illustration of the transforming station 4 with the transport device or the carrier 22 of the transport device 2. In FIG. 3a the carrier 22 is arranged vertically and the holding means or holder 26 run here in a plane which is formed by a longitudinal direction L of the plastic parisons on the one hand and by a direction perpendicular to the drawing plane. In the embodiment illustrated in FIG. 3b the carrier 22 extends obliquely with respect to the longitudinal direction L of the plastic parisons. In the arrangement illustrated in FIG. 3c the carrier is arranged horizontally. In addition, FIG. 3b also shows the valve unit 40 which in this case is arranged in the interior of the space surrounded by the frame 30.

In the representation shown in FIG. 1, the linear oven 80 is arranged on the right of the transport path P in the running direction of the plastic parisons. Also, in the embodiment shown in FIG. 1 the centre of the respective blow moulds 12 is arranged on the right of the carrier 22 in this transport direction or running direction. As shown in FIGS. 3a and 3c, the respective transport circle which conveys the plastic parisons to the transforming station is arranged perpendicularly, horizontally or obliquely (FIG. 3c).

FIGS. 4a-4c show three possible representations of transforming devices. In the embodiment shown in FIG. 4a the frame 30 or the wall 30 is completely closed around the transforming station in the circumferential direction. In the embodiment shown in FIG. 4b the frame is open upwards. In the embodiment shown in FIG. 4c the plastic parisons are guided below the transforming station, wherein here in particular the plastic parisons are transported in the opposite position than with the mouth downwards. Also, in the embodiment shown in FIG. 4a the valve unit is preferably arranged inside the space delimited by the remaining wall portions.

FIGS. 5a to 5h show a plurality of embodiments of the transport devices or the holding elements thereof. In the embodiment shown in FIG. 5a the transport device extends below the blow moulds and on the left with respect to the centre of the blow moulds in a running direction. The transport element 24 on which the holding element 26 is arranged is angled here.

In the embodiment shown in FIG. 5b a transport element 26 is provided which arranges a holding means or holder such as for instance pincers or a gripper at an angle of 90°. In the embodiments shown in FIGS. 5c and 5d the gripping means or gripper is horizontal with respect to the transport device. In FIGS. 5e and 5f the transport path is fixed at an angle and the gripping means or gripper in turn extends horizontally with respect to the path of movement. In the embodiment shown in FIG. 5g a product or a plastic parison or a container is transported horizontally, and the gripping means gripper extends perpendicularly. In the embodiment shown in FIG. 5h the gripping means or gripper is arranged pivotable.

FIG. 6 shows a detailed representation of a transforming station 8. Here too the blow mould parts 12a and 12b are again illustrated as well as the carriers 14a and 14b which hold them. Furthermore, the locking elements 16a and 16b are shown here in greater detail. It will be recognised that these elements are displaceable in the direction Y, that is to say upwards and downwards, in order to release a corresponding locking mechanism. The reference numeral 52 designates a pressure medium connection, by which a pressure pad can be acted upon which in turn serves for advancing the locking element towards the right here and in order to thus to press the two blow mould parts 12a and 12b against one another.

Furthermore, the transport device or the carrier 22 on which the gripping means or gripper 26 is arranged is again shown. The reference numeral 42 designates an application device such as in particular a blow moulding nozzle which serves for supplying the plastic parisons with blowing air. The reference numeral 40 designates the valve unit, which here is evidently arranged inside the frame or the region surrounded by the wall or walls 30a to 30c. This valve unit 40 is likewise movable in the direction Y. In addition, furthermore, a stretching rod can be provided which can be introduced into the plastic parisons in order to expand them in the longitudinal direction.

As mentioned above, the two blow mould carrier parts 14a and 14b can be movable in the direction X in order to open and close the blow mould. The base part 17 can be movable in the direction Y in order to be advanced likewise towards the plastic parison during closing. In this case a drive can be provided, such as a coupling device, which couples the movement of the blow mould carrier part 14b to that of the blow mould carrier part 14a. Thus, for example, a linkage can be provided which causes the two blow mould carrier parts 14a and 14b to be retracted simultaneously or to be advanced towards a plastic parison. In this case the base part 16 can also be coupled by means of a further coupling device. Thus, by means of one single driving device, for example a linear motor or a pneumatic drive, both the two side parts 14a and 14b and also the base part 16 can be moved in order thus to open and close the blow mould.

FIG. 7 shows an illustration of the locking mechanism in four partial representations. Here again a right-hand blow mould part 12a is shown schematically, as well as also the blow mould carrier 14a thereof. Furthermore, the locking element 16a is illustrated which—as indicated by the vertical arrows (cf. right-hand part-drawings)—can be moved. As shown in the two right-hand part-drawings, due to such a displacement of the locking element the locking mechanism can be released and so with a predetermined stroke the blow mould part can be moved towards the right in order thus to open the blow mould. In a closed state—as illustrated in the left-hand part-drawing—a small gap will be produced, but this can be closed by an additionally acting on it for example by means of a pressure pad

FIG. 8 shows a further schematic representation of a part of a transforming station 4. In this case again a blow mould part 12b is shown, as well as a carrier 14b on which this blow mould part is arranged. In addition, the locking mechanism 16b can also be seen. The reference numerals 35 and 37 designate rails which serve for guiding the slide 34, on which the blow mould carrier 14b is in turn arranged. These two rails are arranged fixedly on the wall portion 30c. The reference numeral 25 designates a pressure pad which is arranged between the blow mould carrier 14b and the blow mould part 12b. If this pressure pad is acted upon by compressed air, a side part of this blow mould can (in particular in a closed state of the blow mould) be pushed onto the other side part of this blow mould.

The reference numeral 6 designates a closing mechanism or a closing unit for closing the blow mould. In this case the reference numeral 50 designates a central drive which serves here for opening and closing the blow mould. This drive 50 is a linear drive here. Furthermore, it can be recognised that the blow mould here has two cavities 19 for blow moulding of plastic bottles. Thus, this blow mould enables a simultaneous production of two plastic bottles.

FIG. 9 shows an exploded view of the coupling mechanism which couples the movements of the individual blow mould parts to one another. This coupling mechanism is a component of the closing mechanism 6. Two linkage elements can be seen here which are pivotable arranged on a common carrier 51. This carrier 51 can be moved by the driving device 50 in a straight direction. A pivot element 54 which converts the movement of the linkage element 56 into a movement of the blow mould parts is in turn arranged on these two linkage elements 52. A further linkage element serves for movement of the base part carrier 58 of the blow mould. The reference numeral 55 designates a further linkage element for force transmission.

FIG. 10 shows a further representation of a transforming device. The reference numeral 60 relates to a stretching rod drive which serves for driving two stretching rods 62. This stretching rod drive is preferably arranged above the housing or the walls 30. For this purpose, the upper wall portion 30c can have an opening through which the stretching rod is introduced. In this way nevertheless, the region surrounded by the walls 30a-30d can be kept low.

It will be recognised that here once again the valve unit 40 and the transport device 22 are arranged inside the circumferential walls designated by 30. In addition, the drive unit 50 with the coupling devices can also be recognised below the actual blow moulds 12a, 12b.

FIG. 11 shows a further embodiment of the present invention. As mentioned above, it would be desirable if between the oven 80 and the transforming stations 4 all the plastic parisons take the same time or the same path. For this purpose, the transport paths of the plastic parisons can be distributed as illustrated in FIG. 11. Here too a feed 18 is shown which feeds the plastic parisons initially to the heating device 80. After this heating device 80 handling units can be provided, such as for instance a module 93, which enables a different temperature regulation of different regions of the parisons (for example in order to produce oval bottles).

In addition, a sterilising device 94 can be provided which sterilises the inner region of the plastic parisons. It would also be conceivable to provide a temperature equalisation path 96 in this region. By means of a first diverting device 102 the plastic parisons are now distributed to several transforming stations 4 and substantially simultaneously are blow moulded to form containers. After this blow moulding process, the manufactured containers are brought together again by means of a further diverting device 104. The reference numeral 110 designates a secondary treatment zone, in which for example a container inspection or secondary cooling of a base can take place. The reference numeral 118 designates a discharge device for the plastic parisons. Thus, the system illustrated in FIG. 11 is a partially modular structure.

FIG. 12 shows a fully modular structure. In this embodiment in each case a heating device 80 and the devices 93, 94 and 96 as well as 110 are associated with each transforming station 4. The first diverting device 102 performs a distribution to several branches from ovens and transforming stations (the further branches are represented by broken lines). After the completed blow moulding process, the containers are brought together in a further diverting device or combining device 104 and are discharged by means of the discharge device 118.

In the embodiment illustrated in FIG. 13 the plastic parisons are likewise distributed by means of a plurality of diverting devices to a plurality of parallel transforming stations 4.

FIG. 14 shows a further schematic representation of such a distribution. In this distribution the plastic parisons are located here at the bottom left and are distributed to a plurality of transforming stations 4. These individual transforming stations each have two cavities for blow moulding of bottles. Here the finished bottles are then discharged again at the top left.

FIG. 15 shows a further embodiment of a possible distribution of the transport. Here the plastic parisons are first distributed to two branches 112a and 112b of transforming stations 4 and are then the finished containers are brought together again at the point P2.

Although the invention has been illustrated and described in greater detail with reference to the preferred exemplary embodiment, the invention is not limited to the examples disclosed, and further variations can be inferred by a person skilled in the art, without departing from the scope of protection of the invention.

For the sake of clarity, it is to be understood that the use of “a” or “an” throughout this application does not exclude a plurality, and “comprising” does not exclude other steps or elements.

### LIST OF REFERENCES

1 apparatus
2 (first) transport device
4 transforming station
6 closing mechanism
10 plastic parisons
12 blow mould
12a, b blow mould parts, side parts
14a, 14b side part carrier
16a, 16b locking element
17 base part
18 delivery device
19 cavity
20 plastic containers
22 carrier
24 transport element
26 holding element
30 frame
30a-30d wall portions of the frame 30
32 slide
40 valve unit
42 application device
50 drive
51 carrier
52, 54, 55 linkage elements
56 linkage element for base part
58 base part carrier
62 stretching rod
80 oven
82 transport device
84 carrier
86 transport element
88 heating devices
92 holding devices
93 module
94 sterilising device
96 temperature equalising path
102, 104 diverting device
110 secondary treatment zone
112a, b branches
118 discharge device
L longitudinal direction of the plastic parisons
X, Y directions
P2 combining point

1. An apparatus for transforming plastic parisons into plastic containers with a transport device which transports the plastic parisons along a predetermined transport path, with at least one transforming station which is arranged in a stationary manner along this transport path, wherein the transforming station has a blow mould which can be opened and closed and which in a closed state forms a cavity inside which the plastic parisons can be transformed into the plastic containers by the application of a gaseous medium, and wherein the transforming station has a closing unit in order to close the blow mould and this closing unit has at least one component of the blow mould which is movable relative to another component of the blow mould, and wherein, furthermore, the transforming station has an application device, which can be applied to a region of the plastic parisons and/or of the blow moulds, in order to apply the gaseous medium to these plastic parisons, as well as a valve unit, in order to control the delivery of the gaseous medium to be delivered to the plastic parisons, wherein the closing unit has a wall surrounding the blow mould at least partially in a circumferential direction and the valve unit is arranged inside this wall.

2. The apparatus according to claim 1, wherein the transport device has a carrier as well as transport elements which are arranged on this carrier and are movable independently of one another relative to this carrier.

3. The apparatus according to claim 2, wherein the transport device has magnetic driver for moving the transport elements.

4. The apparatus according to claim 2, wherein the wall is formed as a frame and parts of the blow mould are fastened on this frame.

5. The apparatus according to claim 2, wherein the frame provides a force for locking the at least one blow mould.

6. The apparatus according to claim 2, wherein the apparatus has a locking mechanism for locking blow mould parts.

7. The apparatus according to claim 2, wherein the apparatus has at least two blow moulds which are suitable and intended for transforming plastic parisons.

8. The apparatus according to claim 2, wherein the transport device has a diverting device which distributes at least one supply transport strand from the transport device into at least two continuing transport strands.

9. The apparatus according to claim 2, wherein the apparatus has a heating device for heating the plastic parisons to be delivered to the blow moulds, as well as a second transport device which conveys the plastic parisons through this heating device, wherein this second transport device preferably has a carrier as well as transport elements which are arranged on this carrier and are movable independently of one another relative to this carrier.

10. The apparatus according to claim 9, wherein at least one element of the heating device is arranged laterally alongside the transport path of the plastic parisons transported by the first transport device, and is arranged on the right with respect to this transport path in a transport direction of the plastic parisons.

11. A method for transforming plastic parisons into plastic containers, wherein plastic parisons are transported by a transport device along a predetermined transport path, and are transformed into the plastic containers by means of at least one transforming station which is arranged in a stationary manner along this transport path, wherein the transforming station has a blow mould which is opened and closed and which in a closed state forms a cavity inside which the plastic parisons are transformed into the plastic containers by the application of a gaseous medium, and wherein the transforming station has a closing unit in order to close the blow mould and this closing unit has at least one component of the blow mould which is movable relative to another component of the blow mould, and wherein, furthermore, the transforming station has an application device, which can be applied to a region of the blow moulds and/or of the plastic parisons, in order to apply the gaseous medium thereto, as well as a valve unit which controls the delivery of the gaseous medium to be delivered to the plastic parisons, wherein the closing unit has a wall surrounding the blow mould at least partially in a circumferential direction and the valve unit is arranged inside this wall.
